(19) United States
(12) Patent Application Publication
(10) Pub. No.: US 2016/0153631 A1
(43) Pub. Date: Jun. 2, 2016

(54) CONTROLLABLE NATURAL INDOOR ILLUMINATION SYSTEM

(71) Applicant: HON HAI PRECISION INDUSTRY CO., LTD., New Taipei (TW)

(72) Inventor: PO-CHOU CHEN, Tu-Cheng (TW)

(21) Appl. No.: 14/610,257

(22) Filed: Jan. 30, 2015

(30) Foreign Application Priority Data
Dec. 2, 2014 (TW) 103141728

(51) Int. Cl. F21S 11/00; G02F 1/163

(52) U.S. Cl. CPC F21S 11/007; G02F 1/163

(57) ABSTRACT

A controllable natural illumination system for a building with an interior space includes a guiding element configured to guide natural illumination from an exterior of the building towards the interior space, an electro-chromic film covering at least a portion of the guiding element, and a controlling device electrically connected to the electro-chromic film. The natural illumination guided by the guiding element to the interior space passes through the electro-chromic film. The controlling device is configured to regulate the light penetrating ratio of the electro-chromic film controlling the natural illumination passable through the electro-chromic film to the interior space.

### FIELD

The subject matter herein generally relates to a controllable natural illumination system, more specifically to a controllable natural illumination system used for providing illumination for an interior of a house.

### BACKGROUND

Many green buildings have begun to use sunlight as indoor lighting during the day, which can save power consumption to achieve the purpose of saving energy. However, since not every room of a house has a window, many products and technologies have been developed to guide the sunlight into an interior of the room without windows. For example, a daylight guiding tube is mounted on a room without windows, to collect and guide sunlight into the interior of the room for indoor lighting during the day. However, the daylight guiding tube as described above can only guide the sunlight into the interior of the room, it cannot control the brightness of the sunlight radiated into the interior of the house in order to meet illumination requirements in different occasions.

### BRIEF DESCRIPTION OF THE DRAWINGS

Implementations of the present technology will now be described, by way of example only, with reference to the attached figures.

FIG. 1 is a diagrammatic view of a controllable natural illumination system for providing illumination for an interior of a house in accordance with a first embodiment of the present disclosure.

FIG. 2 is an enlarged view of the controllable natural illumination system shown in FIG. 1.

FIG. 3 is a cross-sectional view of an electro-chromic film of the controllable natural illumination system of FIG. 1.

FIG. 4 is a diagrammatic view of a controllable natural illumination system for providing illumination for an interior of a house in accordance with a second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

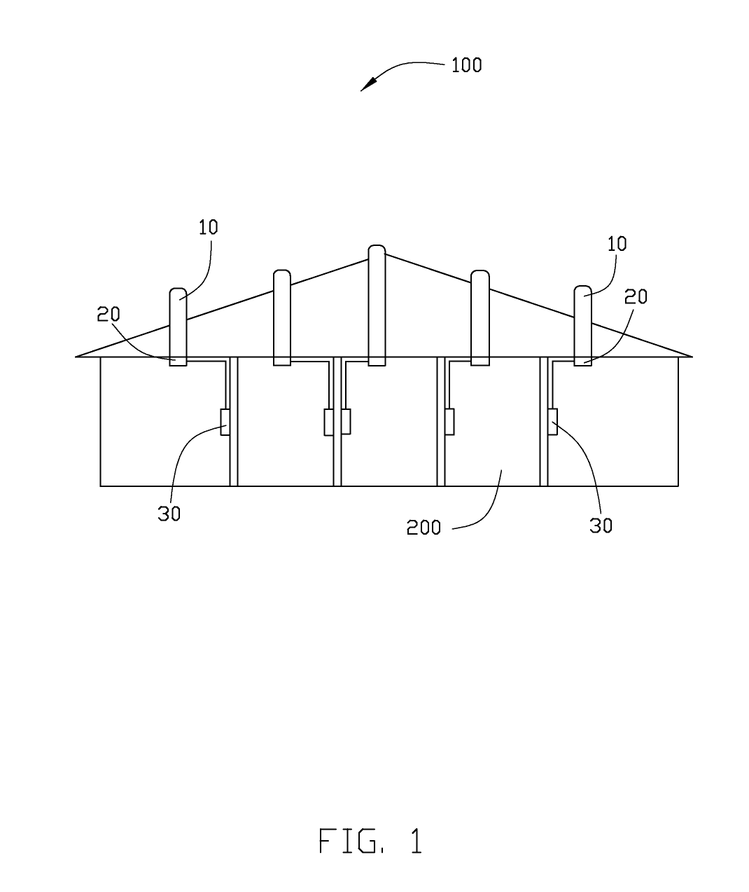

Referring to FIG. 1, a controllable natural illumination system 100 for providing illumination for a building with an interior space in accordance with a first embodiment of the present disclosure is shown. In this embodiment, the building is a house 200. The controllable natural illumination system 100 is configured to be mounted on a top of the house 200, and includes a guiding element 10, an electro-chromic film 20 coupled to the guiding element 10, and a light controlling device 30 electrically coupled to the electro-chromic film 20.

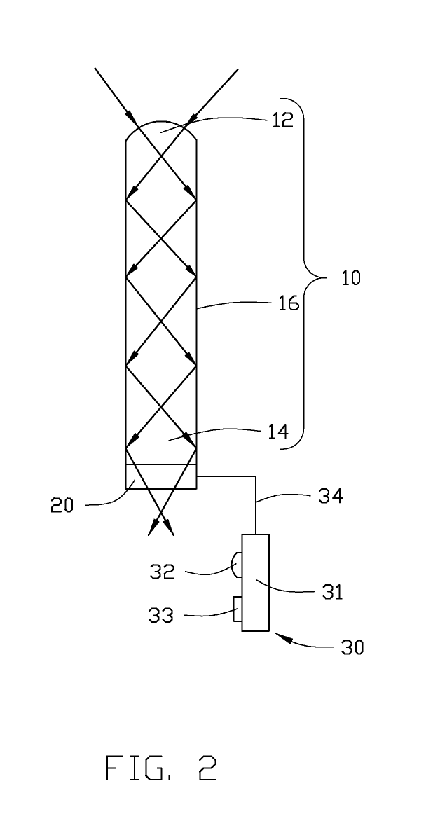

Also referring to FIG. 2, the guiding element 10 is configured to guide sunlight (i.e., natural illumination) from an exterior of the house 200 towards the interior of the house 200. In particular, the guiding element 10 may be a daylight guiding tube. The guiding element 10 is tubular, and includes a light inputting end 12 and a light outputting end 14. The light inputting end 12 is configured to be mounted on the exterior of the house 200 to absorb the sunlight from the exterior of the house 200. The light outputting end 14 is configured to be mounted on the interior of the house 200 to radiate sunlight towards the interior of the house 200. The guiding element 10 has an inner surface 16 configured to reflect the sunlight, so that the sunlight enters an interior of the guiding element 10 from the light inputting end 12, and then is emitted out of the light outputting end 14 after repeatedly reflected by the inner surface 16 of the guiding element 10.

The electro-chromic film 20 is coupled to the light outputting end 14 of the guiding element 10. The sunlight outputted from the light outputting end 14 of the guiding element 10 penetrates the electro-chromic film 20 to provide illumination for the interior of the house 200.

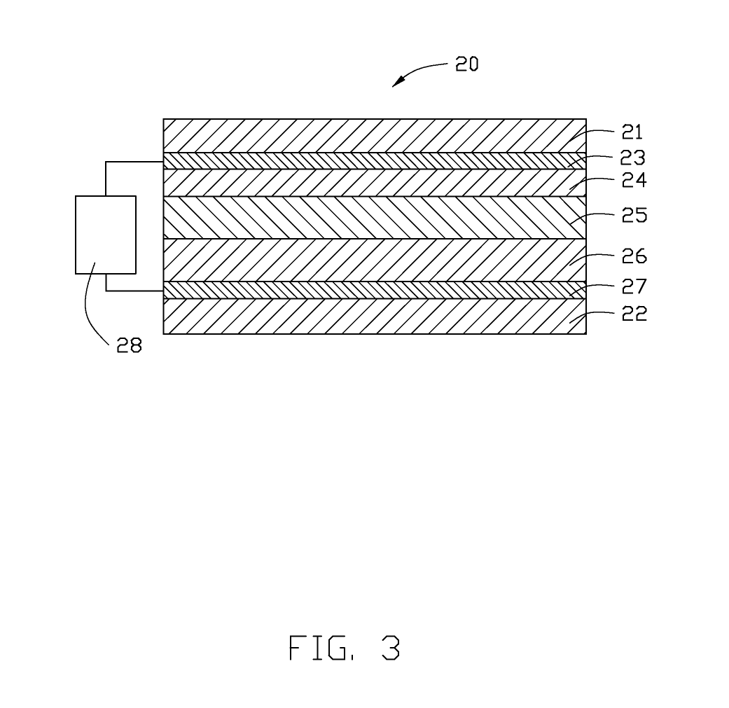

Also referring to FIG. 3, the electro-chromic film 20 includes a transparent conductive substrate 23, an ionized storage layer 24, an electrolyte layer 25, an electro-chromic layer 26, and a transparent conductive substrate 27 formed between two glass substrates 21 and 22.

When the electro-chromic film 20 works, a certain voltage 28 is applied between the two transparent conductive substrates 23 and 27. A reversible oxidation-reduction reaction inside the electro-chromic layer 26 is caused under the effect of the voltage 28, resulting in reversible changes of the optical properties (e.g., the light penetrating ratio) of the electro-chromic film 20 in the visible light wavelength range. The electrolyte layer 25 is composed of special conductive materials, such as solution or solid electrolyte materials containing lithium perchlorate, sodium perchlorate materials etc. The ionized storage layer 24 performs functions of storing counter ions and maintaining electric charge balance when the reversible oxidation-reduction reaction occurs in the electro-chromic layer 26.

The light controlling device 30 is configured to regulate the light penetrating ratio of the electro-chromic film 20 so as to control the brightness of the sunlight outputted from the electro-chromic film 20 and finally radiated in the interior of the house 200 according to requirements. In this embodiment, the light controlling device 30 includes a control circuit 31, a light sensing controller 32, and a manual controller 33. The control circuit 31 is electrically coupled to the electro-chromic film 20 by a wire 34. The light sensing controller 32 is configured to automatically regulate the light penetrating ratio of the electro-chromic film 20 according to the predetermined indoor illumination brightness. The manual controller 33 is configured to manually regulate the light penetrating ratio of the electro-chromic film 20.

It should be understood that, in other embodiments, the light controlling device 30 may include only one of the light sensing controller 32 and the manual controller 33 according to requirements.

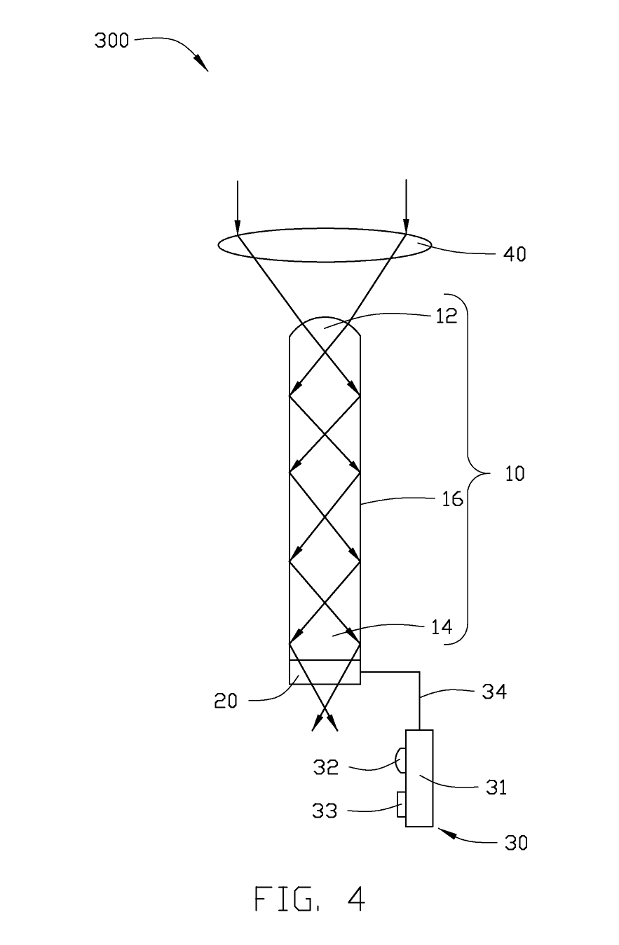

Referring to FIG. 4, a controllable natural illumination system 300 for providing illumination for a building with an interior space in accordance with a second embodiment of the present disclosure is shown. The differences between the controllable natural illumination system 300 of the second embodiment and the controllable natural illumination system 100 of the first embodiment are in that: the controllable natural illumination system 300 further includes a light collecting element 40 disposed above the light inputting end 12 of the guiding element 10. The light collecting element 40 is configured to converge the outdoor sunlight at the light inputting end 12 of the guiding element 10. In particular, the light collecting element 40 may be a lens.

According to the present disclosure, since the electro-chromic film 20 and the light controlling device 30 for regulating the light penetrating ratio of the electro-chromic film 20 are applied to the guiding element 10, so that the controllable natural illumination system 100, 300 can control the brightness of the sunlight radiated in the interior of the house 200 to meet illumination requirements in different occasions.

The embodiments shown and described above are only examples. Many details are often found in the art such as the other features of a controllable natural illumination system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A controllable natural illumination system for a building with an interior space, the system comprising:
a guiding element configured to guide natural illumination from an exterior of the building towards the interior space;
an electro-chromic film covering at least a portion of the guiding element; and
a controlling device electrically connected to the electro-chromic film;
wherein, the natural illumination guided by the guiding element to the interior space passes through the electro-chromic film; and
wherein, the controlling device is configured to regulate the light penetrating ratio of the electro-chromic film controlling the natural illumination passable through the electro-chromic film to the interior space.

2. The controllable natural illumination system of claim 1, wherein the guiding element is a daylight guiding tube.

3. The controllable natural illumination system of claim 1, wherein the guiding element comprises a light inputting end, the light inputting end being configured to be mounted on the exterior of the building for absorbing the natural illumination from the exterior of the building.

4. The controllable natural illumination system of claim 3, wherein the guiding element further comprises a light outputting end, the light outputting end being configured to be mounted on the interior of the house for radiating the natural illumination towards the interior space.

5. The controllable natural illumination system of claim 4, wherein the electro-chromic film is coupled to the light outputting end of the guiding element.

6. The controllable natural illumination system of claim 5, wherein the guiding element has an inner surface for reflecting the natural illumination, so that the natural illumination enters an interior of the guiding element from the light inputting end, and then is emitted out of the light outputting end after repeatedly reflected by the inner surface of the guiding element.

7. The controllable natural illumination system of claim 1, wherein the light controlling device comprises a control circuit, the control circuit being electrically coupled to the electro-chromic film by a wire.

8. The controllable natural illumination system of claim 7, wherein the light controlling device further comprises a light sensing controller, the light sensing controller being configured to automatically regulate the light penetrating ratio of the electro-chromic film according to the predetermined indoor illumination brightness.

9. The controllable natural illumination system of claim 8, wherein the light controlling device further comprises a manual controller, the manual controller being configured to manually regulate the light penetrating ratio of the electro-chromic film.

10. The controllable natural illumination system of claim 7, wherein the light controlling device further comprises a manual controller, the manual controller being configured to manually regulate the light penetrating ratio of the electro-chromic film.

11. A controllable natural illumination system for a building with an interior space, the system comprising:
a guiding element configured to guide natural illumination from an exterior of the building towards the interior space;
a light collecting element configured to converge the natural illumination at the guiding element;
an electro-chromic film covering at least a portion of the guiding element; and
a controlling device electrically connected to the electro-chromic film;
wherein, the natural illumination guided by the guiding element to the interior space passes through the electro-chromic film; and
wherein, the controlling device is configured to regulate the light penetrating ratio of the electro-chromic film controlling the natural illumination passable through the electro-chromic film to the interior space.

12. The controllable natural illumination system of claim 11, wherein the guiding element is a daylight guiding tube.

13. The controllable natural illumination system of claim 11, wherein the guiding element comprises a light inputting end, the light inputting end being configured to be mounted on the exterior of the building for absorbing the natural illumination from the exterior of the building.

14. The controllable natural illumination system of claim 13, wherein the light collecting element is disposed above the light inputting end of the guiding element, the light collecting element converging the natural illumination at the light inputting end of the guiding element.

15. The controllable natural illumination system of claim 13, wherein the guiding element further comprises a light outputting end, the light outputting end being configured to be mounted on the interior space for radiating the natural illumination towards the interior space.

16. The controllable natural illumination system of claim 15, wherein the electro-chromic film is coupled to the light outputting end of the guiding element.

17. The controllable natural illumination system of claim 16, wherein the guiding element has an inner surface for reflecting the natural illumination, so that the natural illumination enters an interior of the guiding element from the light inputting end, and then is emitted out of the light outputting end after repeatedly reflected by the inner surface of the guiding element.

18. The controllable natural illumination system of claim 11, wherein the light controlling device comprises a control circuit, the control circuit being electrically coupled to the electro-chromic film by a wire.

19. The controllable natural illumination system of claim 18, wherein the light controlling device further comprises a light sensing controller, the light sensing controller being configured to automatically regulate the light penetrating ratio of the electro-chromic film according to the predetermined indoor illumination brightness.

20. The controllable natural illumination system of claim 19, wherein the light controlling device further comprises a manual controller, the manual controller being configured to manually regulate the light penetrating ratio of the electro-chromic film.
